(19) United States
(12) Patent Application Publication
(10) Pub. No.: US 2007/0031094 A1
(43) Pub. Date: Feb. 8, 2007

(54) Optical fiber cable

(75) Inventors: Misao Watahiki, Hitachi (JP); Ryo Nagai, Hitachi (JP); Takahiro Sato, Hitachi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: HITACHI CABLE, LTD., Tokyo (JP)

(21) Appl. No.: 11/493,917

(22) Filed: Jul. 27, 2006

(30) Foreign Application Priority Data
Aug. 4, 2005 (JP) 2005-226738

(51) Int. Cl. G02B 6/44

(52) U.S. Cl. 385/102; 385/100; 385/104; 385/106; 385/107

(57) ABSTRACT

An optical fiber cable has: a cable portion having an optical fiber tape core wire that a plurality of optical fiber core wires are stacked in parallel, and a cable sheath formed on the plurality of optical fiber core wires; and mold-releasing sheets disposed in parallel with the optical fiber tape core wire. The mold-releasing sheets have an end portion extended from the end of the optical fiber tape core wire. An end of the optical fiber tape core wire is covered by the end portion of the mold-releasing sheet.

The present application is based on Japanese patent application No. 2005-226738, the entire contents of which are incorporated herein by reference.

### BACKGROUND OF THE INVENTION

1. Field of the Invention

This invention relates to an optical fiber cable, in particular, to an optical fiber cable that is capable of being installed inside an underground pipeline or between electrical poles and further drawn into a building, a house etc. from an electrical pole.

2. Description of the Related Art

In recent years, in order to realize high-speed and large-capacity communications for FTTH (=Fiber To The Home) etc., tape stack type optical fiber cables with multiple optical fibers stacked are widely installed in the air and under the ground.

FIG. 10 is a cross sectional view showing a conventional tape stack type optical fiber cable. As shown in FIG. 10, the optical fiber cable 100 comprises a cable portion 102 to accommodate optical fiber tape core wires (fiber tape unit) 101, and a support wire portion 103 to support the cable portion 102. The cable portion 102 and the support wire portion 103 are arranged in parallel to each other and connected through a neck portion 104.

The cable portion 102 comprises a pair of tension members (as a member with high tensile strength), 105, 105 disposed along the two stacked four-core optical fiber tape core wires 101, 101, and a cable sheath 106 of thermoplastic resins such as PE, fire-retardant PE and PVC to coat integrally the optical fiber tape core wire 101 and the tension members 105. On both sides (in the horizontal direction in FIG. 10) of the cable portion 102, notches 107 are formed which are used to extract the optical fiber tape core wire 101 from the cable portion 102 by breaking the cable sheath 106. The tension member 105 is made of a conductive metallic wire or a nonconductive metallic wire such as glass fibers and plastics.

The support wire portion 103 comprises a support wire 108 made of a metallic wire such as a copper wire, and a support-wire sheath 109 to coat the support wire 108. The support-wire sheath 109 and the neck portion 104 are made of thermoplastic resins like the cable sheath 106.

Related arts of the invention are, e.g., JP-A-2004-271870 and JP-A-2003-315640.

According as demand for the FTTH increases, a process (herein called intermediate after-branching) has been frequently conducted that, the after installing the optical fiber cable 100, the optical fiber tape core wire 101 is extracted from the cable portion 102 at an intermediate position (being installed in the air) so as to branch a single optical fiber core wire from the multi-core optical fiber cable 100.

A process of extracting the optical fiber tape core wire 101 from the optical fiber cable 100 in the intermediate after-branching will be explained below with reference to FIGS. 11 and 12 (where, however, the support wire portion 103 and the neck portion 104 are omitted).

As shown in FIG. 11, the cable sheath 106 is broken to extract the optical fiber tape core wire 101. In this process, nails 112 of tools (detachers) 111 are inserted into the notches 107, 107 at both sides of the cable sheath 106, and then the tools 111 are vertically pulled opposite to each other so as to break the cable sheath 106 by the nails 112. Thereby, the cable sheath 106 is broken at the notches 107 and divided into two portions.

However, a problem arises that, when the cable sheath 106 is divided into the two portions, as shown in FIG. 12, the optical fiber tape core wire 101 may be left without being separated from one cable sheath 106b so that the optical fiber tape core wire 101 cannot be extracted from there.

The reason why the optical fiber tape core wire 101 is left inside the one cable sheath 106b is as follows. The optical fiber tape core wire 101 is placed between the notches 107. Therefore, when dividing the cable sheath 106, the nails 112 being inserted into the notches 107, 107 will press the cable sheath 106 against the optical fiber tape core wire 101. As a result, the optical fiber tape core wire 101 must be adhered to the cable sheath 106.

### SUMMARY OF THE INVENTION

It is an object of the invention to provide an optical fiber cable that its optical fiber tape core wire can be surely extracted from its cable sheath in the process of the intermediate after-branching.

(1) According to one aspect of the invention, an optical fiber cable comprises:

a support wire portion comprising a support wire coated with a sheath;

a cable portion comprising an optical fiber tape core wire that a plurality of optical fiber core wires are stacked in parallel, and a cable sheath coated on the plurality of optical fiber core wires;

a neck portion that combines the support wire portion and the cable portion;

notches formed on both sides of the cable sheath; and

mold-releasing sheets disposed in parallel with the optical fiber tape core wire,

wherein the mold-releasing sheets comprise a wider width than the optical fiber tape core wire, and

an end of the optical fiber tape core wire is covered by an end portion of the mold-releasing sheet.

In the above invention (1), the following modifications and changes can be made.

(i) The end portion of the mold-releasing sheet is defined as a portion extended from the end of the optical fiber tape core wire, and the end portion comprises a length of one fifth or more a diameter of the optical fiber core wire.

(ii) The end portion of the mold-releasing sheet is defined as a portion extended from the end of the optical fiber tape core wire, and the end portion comprises a bending angle of 30 degrees or more, the bending angle being defined inclined toward the optical fiber core wire from a line parallel to a flat portion of the mold-releasing sheet.

(iii) The mold-releasing sheet comprises one of polypropylene, polyethylene terephthalate, and the mold-releasing sheet comprises a thickness of 16 μm to 50 μm.

(2) According to another aspect of the invention, an optical fiber cable comprises:

a cable portion comprising an optical fiber tape core wire that a plurality of optical fiber core wires are stacked in parallel, and a cable sheath formed on the plurality of optical fiber core wires; and

mold-releasing sheets disposed in parallel with the optical fiber tape core wire,

wherein the mold-releasing sheets comprise an end portion extended from the end of the optical fiber tape core wire, and

an end of the optical fiber tape core wire is covered by the end portion of the mold-releasing sheet.

In the above invention (2) the following modifications and changes can be made.

(iv) The end portion comprises a length of one fifth or more a diameter of the optical fiber core wire.

(v) The end portion comprises a bending angle of 30 degrees or more, the bending angle being defined inclined toward the optical fiber core wire from a line parallel to a flat portion of the mold-releasing sheet.

(vi) The mold-releasing sheet comprises one of polypropylene, polyethylene terephthalate, and the mold-releasing sheet comprises a thickness of 16 μm to 50 μm.

### ADVANTAGES OF THE INVENTION

In the optical fiber cable of the invention, the optical fiber tape core wire can be surely extracted from the cable sheath in the process of the intermediate after-branching.

### BRIEF DESCRIPTION OF THE DRAWINGS

The preferred embodiments according to the invention will be explained below referring to the drawings, wherein:

FIG. 1 is a cross sectional view showing an optical fiber cable in a preferred embodiment according to the invention;

FIG. 2 is a cross sectional view showing an optical fiber core wire 30 in FIG. 1;

FIG. 3 is a cross sectional view showing an optical fiber tape core wire 40 in FIG. 1;

FIG. 4 is a cross sectional view showing a dimension of a mold-releasing sheet 20 in FIG. 1;

FIG. 5 is a cross sectional view showing a bent mold-releasing sheet 20 in FIG. 1;

FIG. 6 is a schematic diagram showing manufacturing equipment for the optical fiber cable;

FIG. 7 is a cross sectional view showing a step of extracting the optical fiber tape core wire 40 from the optical fiber cable in FIG. 1;

FIG. 8 is a cross sectional view showing another step of extracting the optical fiber tape core wire 40 from the optical fiber cable in FIG. 1;

FIG. 9A is a cross sectional view showing an example of arrangement for the optical fiber tape core wire 40 and the mold-releasing sheet 20;

FIGS. 9B to 9K are cross sectional views showing modified examples of arrangement for the optical fiber tape core wire 40 and the mold-releasing sheet 20;

FIG. 10 is a cross sectional view showing the conventional optical fiber cable;

FIG. 11 is a cross sectional view showing a step of extracting the optical fiber tape core wire from the optical fiber cable in FIG. 10; and

FIG. 12 is a cross sectional view showing another step of extracting the optical fiber tape core wire from the optical fiber cable in FIG. 10.

### DETAILED DESCRIPTION OF THE PREFERRED EMBODIMENTS

An optical fiber cable in a preferred embodiment of the invention comprises an optical fiber tape core wire (herein also called tape core wire) that has multiple optical fiber core wires connected in parallel.

Optical Fiber Core Wire 30

As shown in FIG. 2, the optical fiber core wire 30 comprises an optical fiber (or optical fiber bare wire) 31 made of a glass material, a first coating layer 32 that covers the optical fiber 31, a second coating layer 33 that covers the first coating layer 32, a colored layer 34 that covers the second coating layer 33, and an overcoat layer 35 that covers the colored layer 34.

The respective layers 32 to 35 are formed concentrically around the optical fiber 31. The first coating layer 32 and the second coating layer 33 serves to protect the optical fiber 31 from a shock or an external injury. The colored layer 34 serves to identify the kind of optical fiber by coloring. The overcoat layer 35 is provided to allow the core wire to have a large diameter sufficient to facilitate the handling thereof when one optical fiber core wire is separated from the optical fiber tape core wire with the multiple optical fiber core wires connected in parallel. The first coating layer 32, the second coating layer 33, the colored layer 34 and the overcoat layer 35 are all made of a UV-curable resin. For example, the overcoat layer 35 may be made of a UV-curable resin that is softer than the first coating layer 32 and harder than the second coating layer 33.

Tape Core Wire 40

As shown in FIG. 3, the tape core wire 40 comprises the four optical fiber core wires 30 as shown in FIG. 2 connected in parallel. The tape core wire 40 is formed such that the optical fiber core wires 30 are arranged in parallel and then are connected by filling a UV-curable resin 41 partially between the optical fiber core wires 30.

Optical Fiber Cable 10

The optical fiber cable 10 of the embodiment will be explained below.

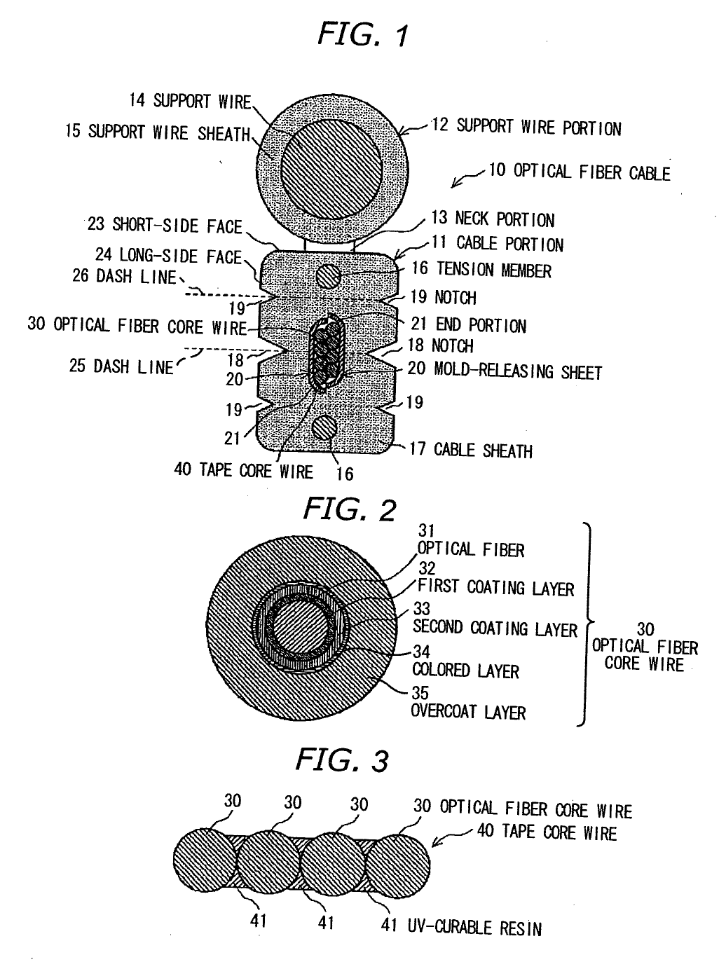

As shown in FIG. 1, the optical fiber cable 10 comprises a cable portion 11 to accommodate the tape core wire 40, a support wire portion 12 to support the cable portion 11, and a neck portion 13 to connect the support wire portion 12 to the cable portion 11.

The support wire portion 12 comprises a support wire (as a member with high tensile strength) 14, and a support wire sheath 15 to coat the periphery of the support wire 14.

The cable portion 11 comprises two sheets of tape core wires 40, at least one (two in FIG. 1) tension member (as a member with high tensile strength) 16 disposed along the tape core wire 40, and a cable sheath 17 to coat the periphery of the tape core wires 40 and the tension member 16. In the cable portion 11, the tension members 16, 16 are disposed on both sides of the tape core wire 40 in a direction where the multiple optical fiber core wires 30 is arranged, and the neck portion 13 is connected to the cable portion 11 in the same direction. By providing the tension members 16, 16, tensile stress can be dispersed into the tension members 16, 16 so that it is not applied to the tape core wire 40. The cable sheath 17 is in its section formed approximately rectangular and vertically long in a direction where the optical fiber core wires 30 are arranged. Hereinafter, a surface of the cable sheath 17 is called a long-side face 24 on the parallel side of the long side of a section of the tape core wire 40, and a short-side face 23 on the perpendicular side of the section of the tape core wire 40.

The neck portion 13 is a member to connect the support wire portion 12 to the cable portion 11, and it is disposed at intervals (intermittently) in the longitudinal direction of the cable portion 11. Alternatively, the neck portion 13 may be disposed continuously in the longitudinal direction of the cable portion 11.

The optical fiber cable 10 can be formed by extrusion molding, where the resin material composing the sheath is extruded around the tape core wire 40, the support wire 14, and the tension member 16. The support wire sheath 15, the cable sheath 17 and the neck portion 13 may be made of the same material.

On each of the long-side faces 24 of the cable portion 11, three notches 19, 18 and 19 are provided that are used to expose the tape core wire 40 by breaking the cable sheath 17. The notches 19, 18 and 19 are each a V-groove (or triangular groove in section) formed continuously in the longitudinal direction of the cable portion 11.

Of the three notches 19, 18 and 19 formed on one of the long-side face 24, the notch 18 at the center is formed such that the tape core wire 40 is located on a line (i.e., a dash line 25 in FIG. 1) that is drawn in parallel to the short-side face 23 from the position of the notch 18. Of the three notches 19, 18 and 19, the notches 19, 19 on both sides of the notch 18 are formed such that the tape core wire 40 is not located on a line (i.e., a dash line 26 in FIG. 1) that is drawn in parallel to the short-side face 23 from the position of the notch 19. The notch 18 at the center has a depth equal to or greater than the notches 19, 19 on both sides of the notch 18.

Mold-Releasing Sheet 20

The optical fiber cable 10 of the embodiment is characterized by that a mold-releasing sheet 20 with a wider width than the tape core wire 40 is vertically attached on both sides of the tape core wire 40, so that the both ends of the tape core wire 40 (i.e., the optical fiber core wires 30 at both ends of the tape core wire 40) can be covered by end portions 21 in the width direction of the mold-releasing sheet 20.

When the tape core wire 40 is extracted by breaking the cable sheath 17, the mold-releasing sheet 20 allows the reduction of the contact area between the cable sheath 17 and tape core wire 40 while covering the tape core wire 40, so that the tape core wire 40 is easy to extract in the process of intermediate after-branching.

The mold-releasing sheet 20 is made of a material that is not adhered to the cable sheath 17, so that it can have a good mold-releasing property in respect to the cable sheath 17. The mold-releasing sheet 20 can be made of polyethylene terephthalate (PET), polypropylene (PP), polyethylene (PE), polyamide (Nylon, registered trade mark) etc. The mold-releasing sheet 20 is formed into a tape by rolling or drawing the material. Alternatively, the mold-releasing sheet 20 may be formed into a tape by weaving a fiber made of a single material or multiple materials (tape woven cloth), or by pressing the fiber (tape unwoven cloth).

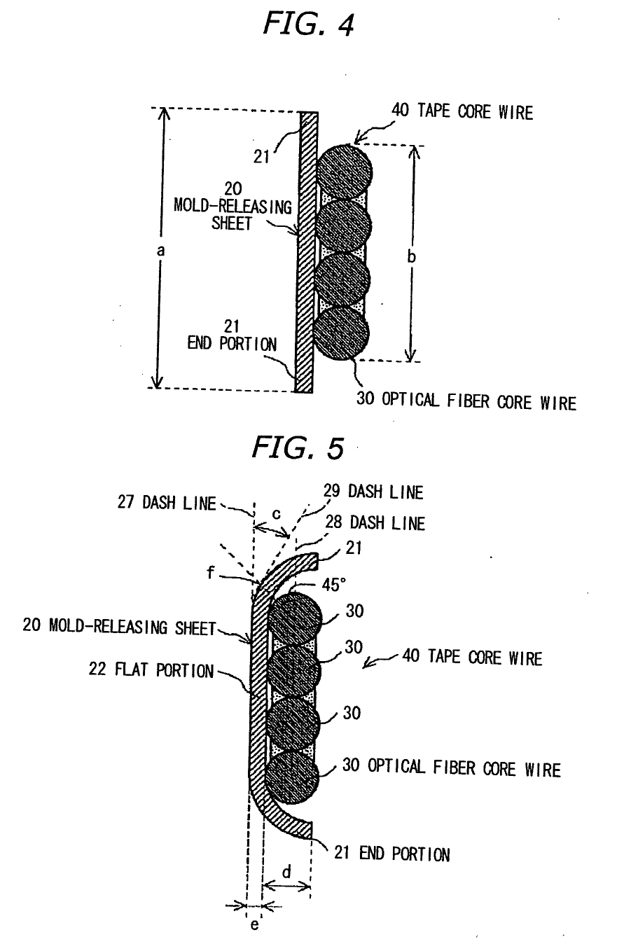

As shown in FIG. 4, the mold-releasing sheet 20 has a width ‘a’ that is larger than the width ‘b’ of the tape core wire 40 so as to cover both ends of the tape core wire 40 by bending the end portions 21, 21 thereof. The width ‘a’ of the mold-releasing sheet 20 is 1.01 times or more the width ‘b’ of the tape core wire 40. Herein, the width ‘a’ means a length of the mold-releasing sheet 20 in the vertical direction.

As shown in FIG. 5, the mold-releasing sheet 20 is bent toward the tape core wire 40 at the end portions 21, 21. The width ‘a’ of the mold-releasing sheet 20 can be designed according to the thickness of the tape core wire 40.

For example, the end portions 21, 21 extended from the respective ends of the tape core wire 40 in the vertical direction have a length sufficient to cover the optical fiber core wire 30 for ⅕ or more of the diameter of the optical fiber core wire 30. In other words, a length ‘d’ of the mold-releasing sheet 20 in a direction perpendicular to a flat portion 22 thereof is formed to be ⅕ or more of the thickness of the tape core wire 40.

Also, it is preferred that the end portion 21 of the mold-releasing sheet 20 extending from the end of the tape core wire 40 in the vertical direction is to cover the end of the tape core wire 40 by being bent 30 degrees or more in bending angle ‘c’ as shown in FIG. 5.

The bending angle ‘c’ means an angle defined by a dash line 27 and a dash line 29 as shown in FIG. 5. The dash line 27 is a line parallel to the flat portion 22 of the mold-releasing sheet 20. The dash line 29 is a tangential line at a point ‘f’ where the mold-releasing sheet 20 intersects with a line obtained by being inclined 45 degrees toward the mold-releasing sheet 20 from a line (indicated by a dash line 28 in FIG. 5) that is parallel to the tape core wire 40 and passes through the center of the optical fiber core wire 30 located at the outermost of the tape core wire 40 and closest to the end portion 21 of the mold-releasing sheet 20.

Further, it is preferred that the mold-releasing sheet 20 has a thickness ‘e’ of 15 to 50 μm. This is because, if the thickness ‘e’ of the mold-releasing sheet 20 is less than 15 μm, it is difficult to keep the shape of the end portion 21 to cover the tape core wire 40 due to the pressure from the resin (for the cable sheath 17) during the extrusion molding. On the other hand, if the thickness ‘e’ of the mold-releasing sheet 20 is greater than 15 μm, it is difficult to bend the end portions 21, 21 due to the increased thickness of the mold-releasing sheet 20.

Method of Making the Optical Fiber Cable 10

A method of making the optical fiber cable 10 will be explained below.

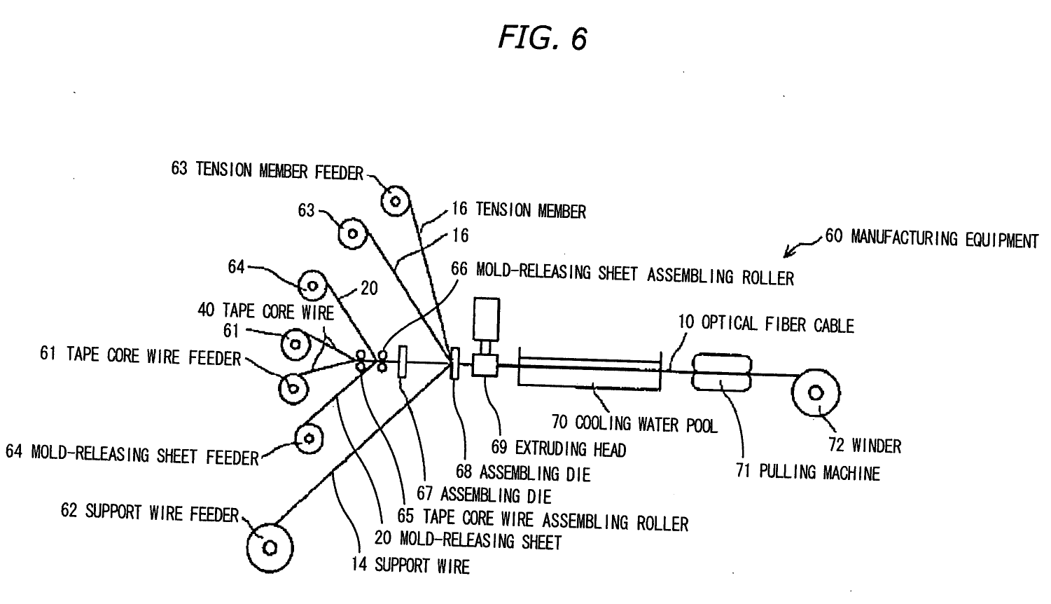

As shown in FIG. 6, manufacturing equipment 60 comprises: an optical fiber tape core wire feeder 61 to feed the optical fiber tape core wire 40; a support wire feeder 62 to feed the support wire 14; tension member feeders 63, 63 to feed the tension members 16, 16; a mold-releasing sheet feeder 64 to feed the mold-releasing sheet 20; an optical fiber tape core wire assembling roller 65 to assemble the optical fiber tape core wire 40; a mold-releasing sheet assembling roller 66 to assemble the mold-releasing sheet 20; assembling dies 67, 68 to assembling the fed wires at a predetermined position, an extruding head 69 to coat the resin for the sheath on the assembled wires; a cooling water pool 70 to cool and harden the resin; a pulling machine 71 to pull the optical fiber cable 10; and a winder (drum) 72 to wind the optical fiber cable 10.

In operation, the two tape core wires 40, 40 fed from the tape core wire feeder 61, 61, respectively, are assembled (stacked) together by the optical fiber tape core wire assembling roller 65. Then, the mold-releasing sheets 20, 20 fed from the mold-releasing sheet feeders 64, 64, respectively, are attached to the outside of the tape core wires 40, 40 by the mold-releasing sheet assembling roller 66, and assembled by the assembling die 67. In this process, it is preferred that the width (in the vertical direction) of the guide of the assembling die 67 which the mold-releasing sheet 20 is passed through is formed slightly narrower (or shorter) than the mold-releasing sheet 20 in order to provide the bend with the end portions 21, 21 of the mold-releasing sheet 20 (See FIG. 5).

Then, by the assembling die 68 downstream, the support wire 14 fed from the support wire feeder 62 and the tension members 16, 16 fed from the tension member feeders 63, 63, respectively, are assembled and guided to be placed at predetermined positions, respectively. Then, in the extruding head 69, the heated resin is extruded into a mold disposed around the wires while allowing the wires (i.e., the support wire 14, the tension members 16, the mold-releasing sheets 20 and the tape core wires 40) to be passed therethrough. Thereby, the support wire portion 12 and the cable portion 11 are formed as well as the neck portion 13.

In this process, the end portions 21, 21 (See FIG. 4) of the mold-releasing sheet 20 are pressed inward by the pressure of the resin extruded from its surrounding since they are protruding from the ends of the tape core wire 40 in the vertical direction. Thus, the end portions 21, 21 are bent to cover the ends of the tape core wire 40. Simultaneously, the notches 18, 19 are formed on the cable sheath 17.

Then, the cable covered with the resin is cooled by the cooling water pool 70 to harden the resin to obtain the optical fiber cable 10. The optical fiber cable 10 obtained is wound by the winder (drum) 72.

Method of Extracting the Tape Core Wire 40 from the Cable Portion 11

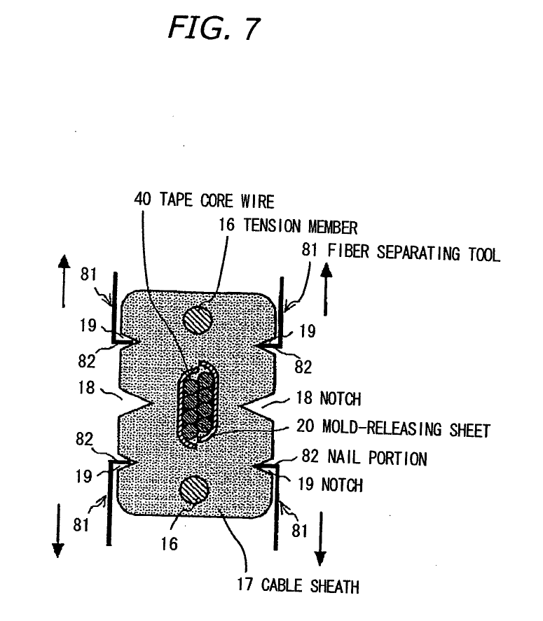

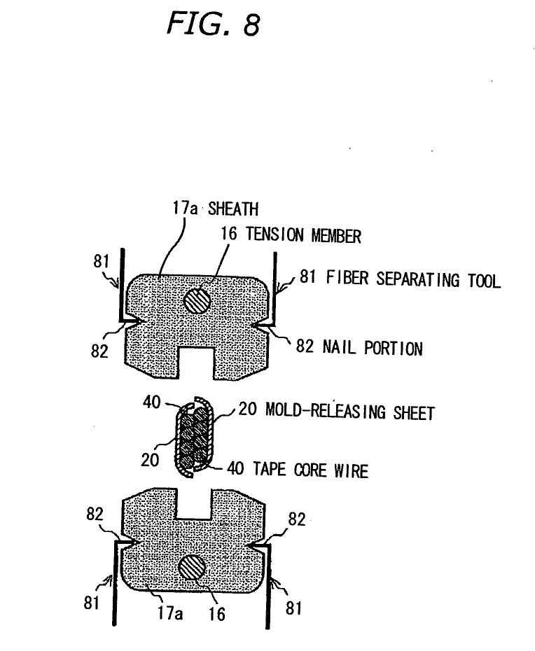

After the optical fiber cable 10 is installed, the tape core wire 40 (installed in the air) may be extracted from the cable portion 11 in the intermediate after-branching process. A method of extracting the mold-releasing sheet 20 will be explained below. However, in FIGS. 7 and 8, the support wire portion 12 and the neck portion 13 are omitted.

As shown in FIG. 7, in the optical fiber cable 10 installed, nail portions 82 of a fiber separating tool 81 are inserted into the end notches 19, 19 on the long-side faces 24, 24 of the cable portion 11. After the nail portions 92 are inserted, the tools 81 are pulled opposite to each other (as shown by arrows in FIG. 7).

As shown in FIG. 8, due to the pulling force of the fiber separating tool 81, the cable sheath 17 will be broken at the center notch 18 and separated into two sheathes 17a, 17b. The reason why the cable sheath 17 is broken at the center notch 18 is that the thickness of the cable sheath 17 at the center notch 18 is thinner than that at the end notches 19, 19 since the tape core wire 40 is accommodated at a part on the line 25 (See FIG. 1) drawn parallel to the short-side face 23 from the center notch 18 with a deeper depth than the end notches 19, 19.

In the optical fiber cable 10, since the mold-releasing sheet 20 covers all the periphery of the tape core wire 40, there is no part where the tape core wire 40 is in contact with the cable sheath 17. Therefore, the mold-releasing sheet 20 can be easy separated from the cable sheath 17. Simultaneously, the tape core wire 40, which is located between the two mold-releasing sheets 20, can be also easy separated from the cable sheath 17 as well as the mold-releasing sheet 20. Thus, the tape core wire 40 can be surely extracted from the optical fiber cable 10.

Arrangement of the Tape Core Wire 40 and Mold-Releasing Sheet 20

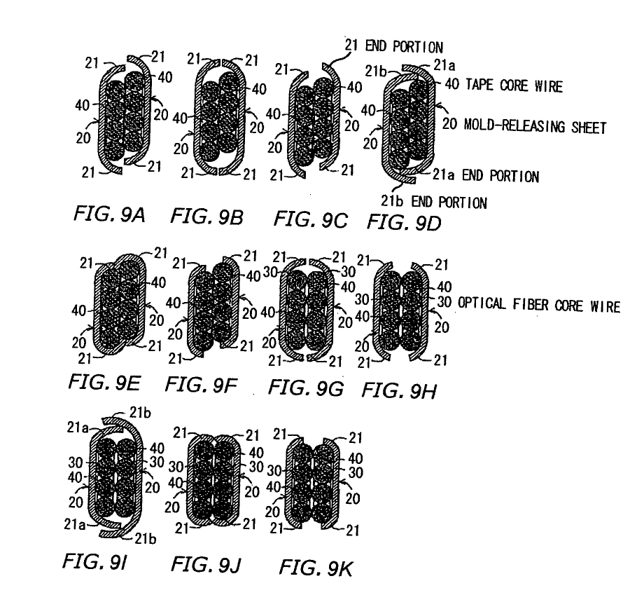

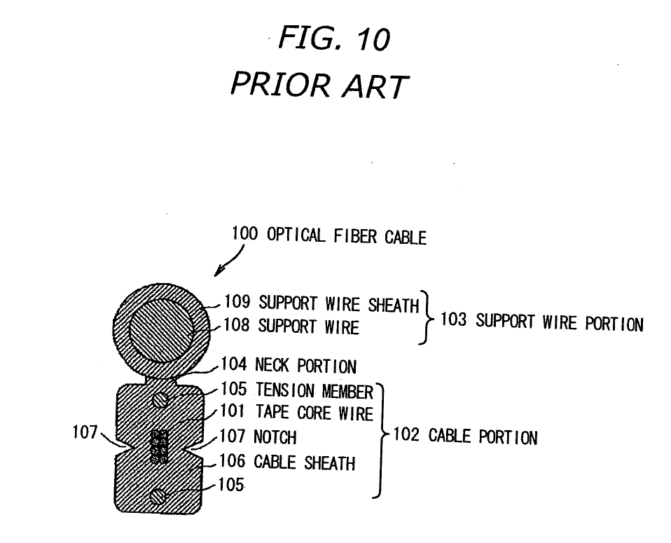

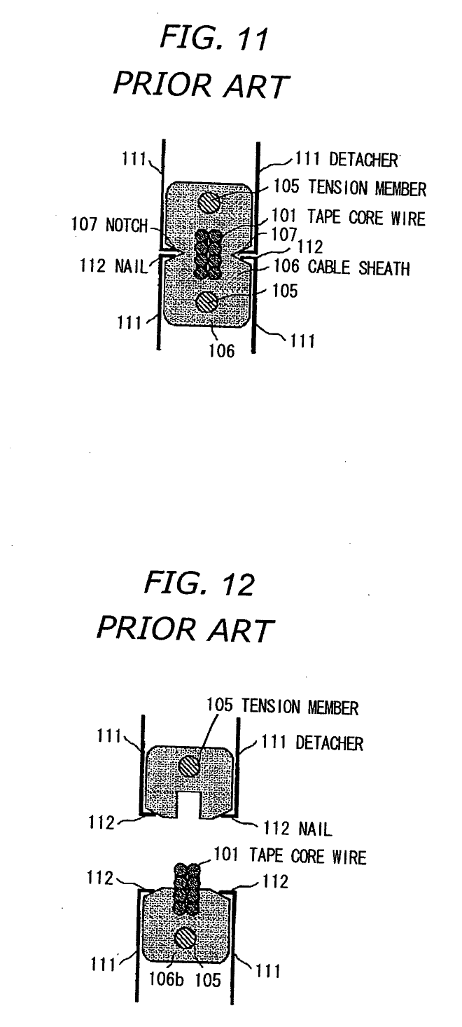

The two sheets of tape core wires 40, 40 and the mold-releasing sheets 20 attached to the tape core wires 40, 40 are, for example, arranged as shown in FIG. 9A and accommodated in the cable sheath 17. In addition, modifications of the arrangement of the tape core wires 40 and the mold-releasing sheets 20 will be described in FIGS. 9B to 9K.

An example in FIG. 9A is arranged such that the tape core wires 40 are stacked displaced by ½ core wire from each other, and the ends of the tape core wire 40 are covered by the end portions 21, 21 of the mold-releasing sheet 20, where the end portions 21, 21 of one mold-releasing sheet 20 are displaced from the corresponding end portions 21, 21 of the other mold-releasing sheet 20.

A modified example in FIG. 9B is arranged such that the tape core wires 40 are stacked displaced by ½ core wire from each other, and the ends of the tape core wire 40 are completely covered by the end portions 21, 21 of the mold-releasing sheet 20 by butting the opposed end portions 21, 21 of the mold-releasing sheets 20, 20.

A modified example in FIG. 9C is arranged such that the tape core wires 40 are stacked displaced by ½ core wire from each other, and the bend of the end portions 21, 21 of the mold-releasing sheet 20 is rendered smaller (or shorter) than that of the mold-releasing sheet 20 in FIG. 9A, whereby the ends of the tape core wire 40 are opened partially.

A modified example in FIG. 9D is arranged such that the tape core wires 40 are stacked displaced by ½ core wire from each other, and the mold-releasing sheets 20, 20 are formed longer than that of the mold-releasing sheet 20 in FIG. 9A, where both ends of the tape core wire 40 are covered by an end 21a of one mold-releasing sheet 20 and an end 21b of the other mold-releasing sheet 20, and an end 21b of the other mold-releasing sheet 20 and an end 21a of the one mold-releasing sheet 20 are stacked on the end 21a of the one mold-releasing sheet 20 and on the end 21b of the other mold-releasing sheet 20, respectively, so that the periphery of the tape core wires 40, 40 is covered completely.

A modified example in FIG. 9E is arranged such that the tape core wires 40 are stacked displaced by ½ core wire from each other, and the end portions 21, 21 of the mold-releasing sheets 20, 20 are bent in close contact with the ends of the tape core wire 40, and the opposed end portions 21, 21 of the mold-releasing sheets 20 are butted each other, so that the periphery of the tape core wires 40, 40 is covered completely by the mold-releasing sheets 20, 20.

A modified example in FIG. 9P is arranged such that the tape core wires 40 are stacked displaced by ½ core wire from each other, and the end portions 21, 21 of the mold-releasing sheets 20, 20 are bent in close contact with the ends of the tape core wire 40, and the ends of the tape core wire 40 are opened partially.

A modified example in FIG. 9G is arranged such that the tape core wires 40 are stacked so that the optical fiber core wires 30 are disposed in parallel, and the ends of the tape core wire 40 are completely covered by the end portions 21, 21 of the mold-releasing sheet 20 by butting the opposed end portions 21, 21 of the mold-releasing sheets 20, 20.

A modified example in FIG. 9H is arranged such that the tape core wires 40 are stacked so that the optical fiber core wires 30 are disposed in parallel, and the bend of the end portions 21, 21 of the mold-releasing sheet 20 is rendered smaller (or shorter) than that of the mold-releasing sheet 20 in FIG. 9A, whereby the ends of the tape core wire 40 are opened partially.

A modified example in FIG. 9I is arranged such that the tape core wires 40 are stacked so that the optical fiber core wires 30 are disposed in parallel, and the mold-releasing sheets 20, 20 are formed longer than that of the mold-releasing sheet 20 in FIG. 9A, where both ends of the tape core wire 40 are covered by ends 21a of one mold-releasing sheet 20, and ends 21b of the other mold-releasing sheet 20 are stacked on the ends 21a of the one mold-releasing sheet 20, so that the periphery of the tape core wires 40, 40 is covered completely.

A modified example in FIG. 9J is arranged such that the tape core wires 40 are stacked so that the optical fiber core wires 30 are disposed in parallel, and the end portions 21, 21 of the mold-releasing sheets 20, 20 are bent in close contact with the ends of the tape core wire 40, and the opposed end portions 21, 21 of the mold-releasing sheets 20 are butted each other, so that the periphery of the tape core wires 40, 40 is covered completely by the mold-releasing sheets 20, 20.

A modified example in FIG. 9K is arranged such that the tape core wires 40 are stacked so that the optical fiber core wires 30 are disposed in parallel, and the end portions 21, 21 of the mold-releasing sheets 20, 20 are bent in close contact with the ends of the tape core wire 40, and the ends of the tape core wire 40 are opened partially.

In the examples as shown in FIGS. 9A to 9K, the tape core wire 40 as well as the mold-releasing sheet 20 can be separated from the cable sheath 17, so that the tape core wire 40 can be surely extracted from the optical fiber cable 10.

Meanwhile, the mold-releasing sheet 20 to cover the tape core wire 40 is not limited to the examples as shown in FIGS. 9A to 9K.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. An optical fiber cable, comprising:
a support wire portion comprising a support wire coated with a sheath;
a cable portion comprising an optical fiber tape core wire that a plurality of optical fiber core wires are stacked in parallel, and a cable sheath coated on the plurality of optical fiber core wires;
a neck portion that combines the support wire portion and the cable portion;
notches formed on both sides of the cable sheath; and
mold-releasing sheets disposed in parallel with the optical fiber tape core wire,
wherein the mold-releasing sheets comprise a wider width than the optical fiber tape core wire, and
an end of the optical fiber tape core wire is covered by an end portion of the mold-releasing sheet.

2. The optical fiber cable according to claim 1, wherein:
the end portion of the mold-releasing sheet is defined as a portion extended from the end of the optical fiber tape core wire, and
the end portion comprises a length of one fifth or more a diameter of the optical fiber core wire.

3. The optical fiber cable according to claim 1, wherein:
the end portion of the mold-releasing sheet is defined as a portion extended from the end of the optical fiber tape core wire, and
the end portion comprises a bending angle of 30 degrees or more, the bending angle being defined inclined toward the optical fiber core wire from a line parallel to a flat portion of the mold-releasing sheet.

4. The optical fiber cable according to claim 1, wherein:
the mold-releasing sheet comprises one of polypropylene, polyethylene terephthalate, and
the mold-releasing sheet comprises a thickness of 16 μm to 50 μm.

5. An optical fiber cable, comprising:
a cable portion comprising an optical fiber tape core wire that a plurality of optical fiber core wires are stacked in parallel, and a cable sheath formed on the plurality of optical fiber core wires; and
mold-releasing sheets disposed in parallel with the optical fiber tape core wire,
wherein the mold-releasing sheets comprise an end portion extended from the end of the optical fiber tape core wire, and
an end of the optical fiber tape core wire is covered by the end portion of the mold-releasing sheet.

6. The optical fiber cable according to claim 5, wherein:
the end portion comprises a length of one fifth or more a diameter of the optical fiber core wire.

7. The optical fiber cable according to claim 5, wherein:
the end portion comprises a bending angle of 30 degrees or more, the bending angle being defined inclined toward the optical fiber core wire from a line parallel to a flat portion of the mold-releasing sheet.

8. The optical fiber cable according to claim 5, wherein:
the mold-releasing sheet comprises one of polypropylene, polyethylene terephthalate, and
the mold-releasing sheet comprises a thickness of 16 μm to 50 μm.
